(19) United States
(12) Patent Application Publication
(10) Pub. No.: US 2024/0354798 A1
(43) Pub. Date: Oct. 24, 2024

(54) A DATA ANALYTICS SYSTEM FOR ANALYSING CONSUMER PURCHASING AND SEARCH BEHAVIOUR

(71) Applicant: SKASH LTD., Nicosia (CY)

(72) Inventor: Arz MURR, Nicosia (CY)

(21) Appl. No.: 18/574,460

(22) PCT Filed: Jun. 29, 2022
(86) PCT No.: PCT/EP2022/067885

§ 371 Date: Dec. 27, 2023

Related U.S. Application Data
(60) Provisional application No. 63/216,084, filed on Jun. 29, 2021.

(30) Foreign Application Priority Data
Jun. 29, 2021 (GB) 2109383.6

(51) Int. Cl. G06Q 30/0207; G06Q 30/0204

(52) U.S. Cl. CPC G06Q 30/0224; G06Q 30/0204; G06Q 30/0222

(57) ABSTRACT

A data analytics system analyses consumer interest data. Instead of increasing consumers' exposure to relevant, targeted advertising for a merchant, implementations of this invention instead give consumers exposure to direct digital financial incentives, such as discounts or coupons delivered to consumers' mobile phones, and directly measuring the actual conversion at the merchant—i.e. directly measuring the actual purchases linked to specific incentives, and then modifying these direct digital financial incentives (e.g. targeting more consumers, targeting different consumers, using different incentives, using more valuable incentives) until the merchant's requirements have been satisfied (e.g. a threshold number has been reached for: new customers, or increased sales).

### FIELD OF THE INVENTION

This invention relates to a data analytics system for analysing consumers' purchases of goods and services.

### PRIOR ART DESCRIPTION

As consumer spending with merchants becomes increasingly digital and cash-less, the intermediaries who enable or facilitate cash-less purchases (both online and physical) harvest valuable data describing consumers' purchasing behaviour. These intermediaries can also harvest valuable data describing consumers' online behaviour when searching for or viewing content or advertising that is relevant to potential purchases of goods or services, as well as consumers' online behaviour when reacting to or posting social media messages that mention or are otherwise relevant to specific goods or services. We shall refer to any or all this data as ‘consumer interest data’: it is data that can be used to describe or predict what goods or services a consumer is or could be interested in purchasing.

The intermediaries that generate ‘consumer interest data’ are broad in scope and include: credit or debit card companies (e.g. VISA), digital payments companies (e.g. Revolut), online retailers (e.g. Amazon), physical retailers (e.g. Walmart), social media companies with targeted digital advertising (e.g. Facebook), as well as online search companies with targeted digital advertising (e.g. Google).

Merchants conventionally pay some sort of fee or commission to the intermediaries that facilitate or enable their online sales or physical but cash-less sales. For example, that might be the transaction or interchange fee the merchant pays to a debit or credit card company or digital payments company when a customer makes a purchase using a debit/credit card or digital payment system. It might be the fee paid to an online retailer (e.g. so-called ‘selling plans’ and ‘referral fees’ charged by Amazon). It might be the listing or slotting or pay-to-stay fee paid to a supermarket or other bricks and mortar retailer. It might be the costs-per-click paid to a social media company or search engine.

Some of these fees are fixed: e.g. credit card transaction fees are conventionally fixed. Some are variable: costs-per-click amount paid to a social media company or search engine can be set by the merchant and the more the merchant is willing to pay, the more extensive or prominent is their advertising.

‘Consumer interest data’ is used for a number of different purposes; for example, it can be used to refine the news, or web search results, or online advertising provided to a consumer so that they are more likely to be relevant and interesting to that consumer. If we focus briefly on online advertising, online retailers and online search companies understand the specific goods previously searched for by a consumer and hence can target that consumer with adverts relating to those types of goods. Social media companies can target advertising to specific consumers that meet advertisers' requirements, for example targeting social media users that meet advertisers' requirements in terms of location, age, gender, interests, connections, relationship status, language, education, workplace, similarity to current users who have previously converted etc. The global annual online advertising market is predicted to reach $1 trillion by 2027.

The underlying technical requirement for these conventional data analytics systems is to analyse ‘consumer interest data’ so that a consumer's purchasing behaviour can be influenced by increasing their exposure to relevant, targeted advertising. Pay-per-click systems of this sort are however vulnerable to click-fraud, and also, just because a consumer clicks on a merchant's advert, that does not mean that the consumer will purchase anything, so they are an inherently inefficient use of merchant's resources in increasing sales.

### SUMMARY OF THE INVENTION

This invention implements a different configuration for a data analytics system that analyses consumer interest data. Instead of increasing consumers' exposure to relevant, targeted advertising for a merchant, implementations of this invention instead give consumers exposure to direct digital financial incentives, such as discounts or coupons delivered to consumers' mobile phones, and directly measuring the actual conversion at the merchant—i.e. directly measuring the actual purchases linked to specific incentives, and then modifying these direct digital financial incentives (e.g. targeting more consumers, targeting different consumers, using different incentives, using more valuable incentives) until the merchant's requirements have been satisfied (e.g. a threshold number has been reached for: new customers, or increased sales).

To achieve this, the computer implemented data analytics system has to be designed to capture: (i) the specific identities of potential consumers that are targeted with one or more financial incentives to purchase goods or services; (ii) the actual value of the financial incentives; (iii) whether the financial incentives were successful in triggering an actual purchase; (iv) the amount of that purchase; and (v) how varying the financial incentives alters actual purchasing behaviour.

Because the data analytics system is capturing this level of detail, in particular directly capturing the linkage between a specific level or kind of financial incentive to purchase defined goods/services, and actually purchasing those goods/services, it becomes possible to incentivise purchasing in a way that is both immune to click fraud and is also far more efficient for the merchant than inherently speculative actions, like conventional online advertising.

It is also more effective than conventional digital coupons: Digital coupon redemption was a global $50 Bn industry in 2017 and has proven to be effective in generating new customers and enhancing customer loyalty; it has been estimated that 31 billion digital coupons were redeemed globally in 2019. However, for merchants, the link between a digital coupon marketing campaign and the increase in new customers or increase in sales is difficult to predict; it is essentially a speculative exercise and there can be no assurance of success in meeting new customer acquisition or sales targets. But with implementations of the present invention, there is a direct, data-driven feedback mechanism that enables the modification of these direct digital financial incentives (e.g. targeting more consumers, targeting different consumers, using different incentives, using more valuable incentives) until merchants' requirements have been met.

The invention will be implemented in the sKash computer-implemented digital payment system, which is described below, but can be implemented by any intermediary or by an entity that operates across multiple intermediaries. Because the sKash system is a digital payment system (offering both physical card and also app-based payments), it enables merchants to stipulate an increase to the transaction fee and for the sKash digital system to then predict what level of increased sales or new customers would then result if the increase in the transaction fees is used to pay for the digital financial incentives sent to potential consumers: it makes the entire process of increasing sales or new customer acquisition data-driven, transparent and efficient, and makes the costs of the increase in sales or new customer acquisition transparent and easy to model financially, since it is simply an increase to the % transaction fee (e.g. an increase in 1% to say 3% or 5% or more).

### BRIEF DESCRIPTION OF THE FIGURES

The invention will be described in relation to one implementation of the invention, the sKash digital payment system.

FIG. 1 shows the overall user experience for the sKash system.

FIGS. 2-5 are flow charts showing the process flow for the following sKash system processes:

FIG. 2: Creating the customer profile base

FIG. 3: Profile tuning the customer

FIG. 4: Creating the merchant profile base

FIG. 5: Matching bidding mechanism for merchants

### DETAILED DESCRIPTION

We will focus on an implementation of the invention, the sKash digital payment system; in one scenario, imagine that there is a new online food delivery platform that wants more new customers in a specific city, say London. Assume the sKash data analytics system tracks a number of people that uses other food delivery platforms in London and elsewhere, all of whom are sKash payment card or app customers. It is hence well positioned to understand which sKash customers are not yet customers of the new food delivery platform, but could be persuaded to try this new platform since they already uses these sorts of platforms. The sKash data analytics system then targets these potential customers with financial incentives to try the new food delivery platform, e.g. 5% discount, or £2 off an order etc. The sKash data analytics system can then measure directly if a purchase is made, redeeming the financial incentive. The sKash data analytics system can identify a cohort of say 1,000 potential customers to target, and can progressively vary the financial incentive offers made to them (e.g. using multivariate techniques) to establish how different offers (e.g. different levels of discounts; different types of offers etc.) lead to different conversion rates; it can progressively optimise (e.g. pareto optimise) the offering to maximise conversion at the optimal cost.

Because the sKash system is a payment system, it charges merchants an interchange fee on transactions; the interchange fee is re-purposed to cover the cost of new customer acquisition and increased sales through the financial incentive offers.

For example, assume the standard interchange fee is 1% of the purchase amount; in the sKash system, a merchant can instead agree to pay 5% or more (e.g. 20%+) on all purchases from new customers in order to gain a target number of new customers, or sales; the sKash data analytics system can then automatically identify suitable potential new customers to target who are likely to be interested in that specific merchant (e.g. because they have previously bought the kinds of goods/services offered by that merchant, or are in a location served by that merchant, or have a demographic profile or set of interests that correlate with other customers who have bought from that merchant, or merchants of the same type). The sKash data analytics system can then automatically send targeted financial incentive offers directly to those potential new customers and monitor whether or not they convert; it can then automatically determine how to adjust the nature and scope of the financial incentives to deliver the conversion rates required by the merchant. Equally, where the merchant wants to incentivise existing customers e.g. to buy different products than they have previously bought, or to buy from vendors they have not previously used), the sKash data analytics system can then automatically identify suitable existing new customers to target with appropriate financial incentives.

The actual cost of customer acquisition can be directly calculated, since the data analytics system tracks all the relevant underlying data, in real time. This enables a merchant to see the actual conversion or actual purchases related to the actual financial incentives, so the increase in sales, and the cost of those sales (including the costs of incentives), can be directly and rapidly seen and measured by the merchant. This should eliminate inefficiencies in the current online advertising model, and hence lead to reduce costs to merchants; it is inherently not open to abuse, such as click-fraud.

The sKash approach requires an entirely new computer-implemented data analytics approach, which can be summarised as follows:

A computer-implemented data analytics method for analysing consumer interest data, comprising the steps, implemented at a data analytics system, of:
(a) automatically analysing potential purchasers' cashless spending behaviour using a machine learning algorithm to generate a dataset that defines the purchasing behaviour of the potential purchasers, the dataset being segmented or organised across a range of different merchants or types of merchants, and also demographic or other personal parameters;
(b) automatically analysing existing purchasers' cashless spending behaviour at a merchant and defining those existing purchasers by a set of merchant-specific demographic or other parameters;
(c) automatically searching the dataset to identify relevant potential purchasers that meet the merchant-specific demographic or other parameters;
(d) enabling the merchant to set or agree a commission percentage or amount to a credit or debit card, or a virtual or digital payment company or an online retailer or a physical retailer or an online advertising company;
(e) using the commission percentage or amount set by the merchant to automatically determine the value of incentives, such as discounts, offers or other benefits, to offer to relevant potential purchasers to purchase goods or services from the merchant.

Optional sKash implementation features include the following; each of these may be combined with any one or more other optional features:
the merchant is automatically shown the predicted increase in sales or customers or other conversion metric associated with different payment commission percentages or amounts, as calculated by an analytics system.
the merchant sets or agrees a desired increase in sales or customers or other conversion metric and is then automatically shown the predicted increase in payment commission percentage or amount, as calculated by an analytics system.
the incentives are offered to relevant potential purchasers on a mobile app that displays a user interface with an icon or other control feature that, if selected by a potential purchaser, displays incentives available to that potential purchaser.
the icon or control feature, if selected, triggers an animation, such as a spinning wheel, and the wheel displays the incentives, such as a discount at the merchant.
the available incentives are incentives from multiple different merchants, and the amount or value of the incentive associated with a specific merchant is a function of the payment commission percentage or amount set by each merchant.
a merchant can set the payment commission percentage or amount by modifying a user interface, such as entering the percentage or amount as figures, or moving a slider or other control feature.
incentives include: discounts, cash back, free additional goods or services, vouchers for any of these that are redeemable once a sufficient number are collected.
the credit or debit card company, such as Visa Inc, Mastercard Incorporated, The American Express Company, exchanges data with the data analytics system over a secure network connection.
the digital payments company, such as Revolut, exchanges data with the data analytics system over a secure network connection.
the incentives are offered to relevant potential purchasers on the website of the online retailer.
the incentives are offered to relevant potential purchasers on online advertising, such as pop-up adverts, banner ads, social media adverts, such as Facebook ads, promoted web search engine results, such as Google Ads promoted web search results.
the benefits to relevant potential purchasers include more prominently listing or otherwise selectively promoting the merchant in an online retailer's search or recommendations results or in web search results.
the online retailer, such as Amazon, exchanges data with the data analytics system over a secure network connection.
the online advertising company, such as Facebook, Google, exchanges data with the data analytics system over a secure network connection.

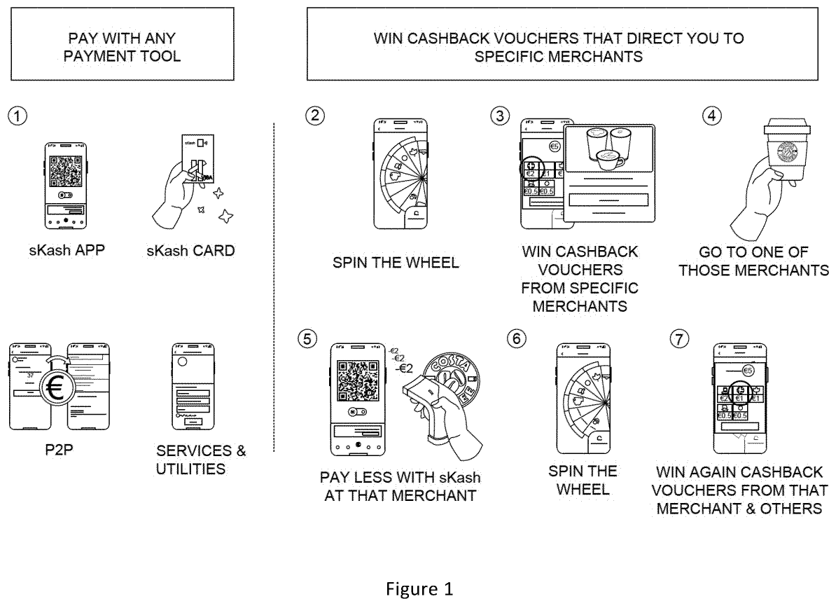

We will look now in more detail at the Figures. FIG. 1 shows the end-user experience, shown over seven steps (Step 1 to Step 7); although the underlying, computer implemented data analytics platform is complex, the sKash end-user experience is simple and intuitive.

Step 1: the end-user pays for an item at a specific merchant using a sKash linked method, such as directly with the sKash mobile phone app, or with a sKash credit card, or with a sKash P2P payment service, or with another form of sKash service. The back end sKash data analytics system then, in background, automatically analyses the end-user's cashless spending behaviour using a machine learning algorithm to enhance the dataset that defines the purchasing behaviour of the end-user. As noted above, the dataset is segmented or organised across a range of different merchants or types of merchants, and also demographic or other personal parameters. The sKash data analytics system also automatically analyses the end-user's cashless spending behaviour at the specific merchant, defining the end-user by a set of merchant-specific demographic or other parameters.

Then, in a background process that is not visible to the end-user, the sKash data analytics system works out which incentives to offer the end-user for future purchases from a merchant (this merchant may be the same merchant involved in the Step 1 transaction, or a different merchant; but for clarity, we refer to it as a ‘new’ merchant). For this ‘new’ merchant, the system automatically searches the dataset to identify relevant potential purchasers that meet the merchant-specific demographic or other parameters; it then enables the new merchant to set or agree a commission percentage or amount to a credit or debit card, or a virtual or digital payment company or an online retailer or a physical retailer or an online advertising company; and uses the commission percentage or amount set by the merchant to automatically determine the value of incentives, such as discounts, offers or other benefits, to offer to relevant potential purchasers to purchase goods or services from the merchant. The incentives are offered to relevant potential purchasers on the sKash mobile app that displays a user interface with an icon or other control feature that, if selected by a potential purchaser, displays incentives available to that potential purchaser. The icon or control feature, if selected, triggers an animation, such as a spinning wheel, and the wheel displays the incentives, such as a discount on goods/services bought at the new merchant.

Now returning to FIG. 1, we see at Step 2 the spinning wheel appearing on the original end-users sKash app; the spinning wheel includes a number of different incentives, all of which are targeted to the specific end-user and all of which are funded by the new merchant, and other merchants similarly wishing to secure this specific end-user as a customer. The spinning wheel stops at one incentive; this could be random, or a function of which merchant is paying the most (e.g. to the sKash platform) or which merchant is providing the best incentive to secure this specific end-user as a customer. Once the wheel stops spinning, then details of the specific incentive are shown on the app (see Step 3). In this case, it is a Euro2 cashback from a specific coffee chain (e.g. if the customer buys a Euro2.50 coffee, then Euro2 is returned back, so the end-user only has to pay Euro0.5). Now incentivised to find this coffee chain, the end-user goes to that chain (Step 4) and using their sKash payment app, orders a coffee and pays just Euro0.5 (Step 5).

This purchase starts the entire process again, but this time the sKash data analytics system is enhanced with the data from this last interaction—e.g. the fact that this end-user has been successfully motivated to visit this new merchant by getting a Euro2 cash-back on a coffee. This coffee chain might chose to cement its relationship with this specific end-user by bidding to get its incentive onto the spinning wheel that now is shown on the end-user's sKash app (Step 6) and to be the winning item on the spinning wheel (Step 7).

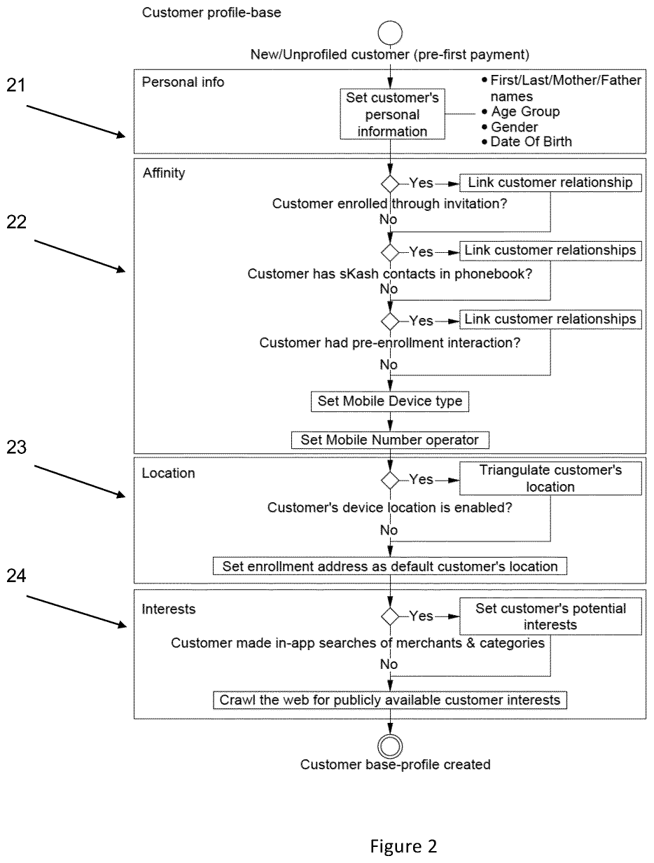

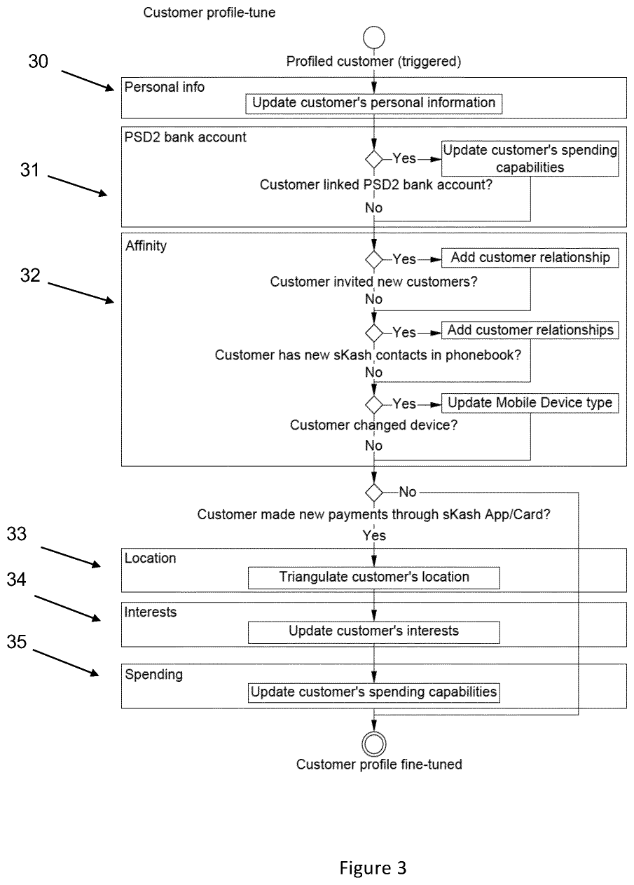

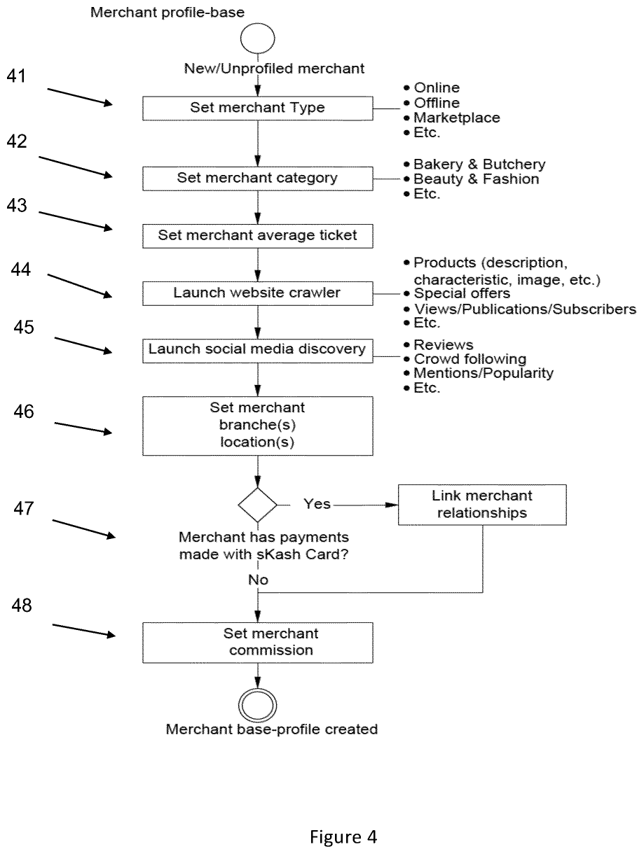

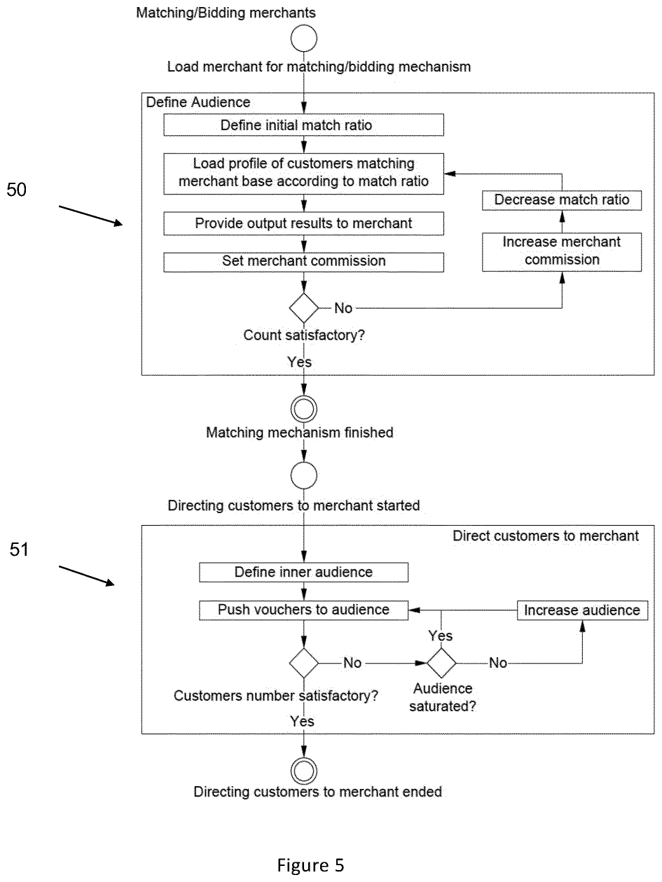

FIGS. 2, 3, 4 and 5 are flow charts showing the process flow for the following processes:
FIG. 2: Creating the customer profile base
FIG. 3: Profile tuning the customer
FIG. 4: Creating the merchant profile base
FIG. 5: Matching bidding mechanism for merchants

These processes may be automatically implemented in the sKash system.

Taking each in turn: FIG. 2, headed ‘Customer profile-base’, describes the process for on-boarding a new customer; it starts with capturing the new customer's personal information 21 and establishing any affinity links 22 between the new customer and existing sKash customers and other sKash relationships. A customer location step 23 follows, and then profiling 24 the customer's interests. This completes the base-profile for this customer.

Each customer profile is refined as the customer engages with the sKash system, as shown in FIG. 3 ‘Customer profile-tune’. In this process flow, any updates to the customers personal information are updated 30, and whether the customer is linked 31 to a PSD2 (EU Payment Services Directive 2, defining open banking) and the capturing 32 the affinity relationships (e.g. whether this customer has invited new sKash customers, whether any new sKash customers are present in the customer's phonebook and whether the customer has changed their mobile phone device). Finally, and most importantly for the operation of the sKash data analytics system, if the customer has made any new payments using an sKash app or card, the location 33 of the customer, the interests 34 of the customer (e.g. merchant type; product or service bought) and the spending profile 35 of the customer are captured. So the sKash system tracks and learns which incentives have worked and which have not and can hence better target that customer with relevant incentives in the future.

FIG. 4 ‘Merchant profile-base’ gives the process flow for on-boarding a new merchant. The process is to set the merchant type 41 (e.g. online, offline etc) and then the merchant category 42 (baker, butcher etc.) and then average ticket size 43 (e.g. average incentive value). A website crawler is launched 44 to crawl the merchant's website for product descriptions, offers etc. Social media discovery 45 searches for online reviews etc. The merchant's physical branch location are then set 46. If the merchant has payments made with a sKash card 47, then a linkage is made to that card. Finally, 48, the merchant's commission payment amount is set. As explained above, one of the benefits of the sKash system is that a merchant can set the commission level at a level that makes sense commercially for that merchant: where customer acquisition for entirely new customers that are known by the sKash system to buy items of the sort the merchant sells, or lives near to the merchant, or is for some other reason an attractive customer to acquire, then the merchant may choose, for example, to pay a higher level of commission until a pre-set new customer acquisition budget has been used up.

FIG. 5 ‘Matching/bidding merchants’ shows the process flow. In the first phase, 50, the audience for a specific merchant's incentive campaign is defined; the match ratio (defining how well a customer has to meet the merchant's requirements) is defined; then, the profiles of customers that meet satisfy this match ratio are loaded; the merchant is then told how many potential customers there are. The merchant sets the incentive amount or commission amount and the system them predicts the count of how many potential customers are likely to become real customers, given that level of incentive. If the count is not satisfactory to the merchant, then the merchant can increase the incentive and/or decrease the match ratio (which has the effect of increasing the number of potential customers that will be targeted). The process is repeated until the count is satisfactory. In the next phase, 51, a customer has made a purchase and is directed to a merchant—e.g. is shown the spinning disc of FIG. 1, and lands on a merchant's incentive and uses the incentive. The process of providing incentives to potential customers for a specific merchant then continues until the number of customers who have actually been converted, i.e. actually used an incentive from that merchant, hits a set threshold.

1. A computer-implemented data analytics method for analysing consumer interest data, implemented at a data analytics system, comprising the steps of:
(a) automatically analysing potential purchasers' cashless spending behaviour using a machine learning algorithm to generate a dataset that defines the purchasing behaviour of the potential purchasers, the dataset being segmented or organised across a range of different merchants or types of merchants, and also demographic or other personal parameters;
(b) automatically analysing existing purchasers' cashless spending behaviour at a merchant and defining those existing purchasers by a set of merchant-specific demographic or other parameters;
(c) automatically searching the dataset to identify relevant potential purchasers that meet the merchant-specific demographic or other parameters;
(d) enabling the merchant to set or agree a payment commission percentage or amount to a credit or debit card company, or a digital payment company, or an online retailer, or a physical retailer or an online advertising company;
(e) using the payment commission amount set by the merchant to automatically determine the value of incentives, such as discounts, offers or other benefits, to offer to relevant potential purchasers to purchase goods or services from the merchant.

2. The data analytics method of claim 1 in which the merchant is automatically shown the predicted increase in sales or customers or other conversion metric associated with different payment commission percentages or amounts, as calculated by an analytics system.

3. The data analytics method of claim 1 in which the merchant sets or agrees a desired increase in sales or customers or other conversion metric and is then automatically shown the predicted increase in payment commission percentage or amount, as calculated by an analytics system.

4. The data analytics method of claim 1 in which the incentives are offered to relevant potential purchasers on a mobile app that displays a user interface with an icon or other control feature that, if selected by a potential purchaser, displays incentives available to that potential purchaser.

5. The data analytics method of claim 4 in which the icon or control feature, if selected, triggers an animation, such as a spinning wheel, and the wheel displays the incentives, such as a discount at the merchant.

6. The data analytics method of claim 1 in which the available incentives are incentives from multiple different merchants, and the amount or value of the incentive associated with a specific merchant is a function of the payment commission percentage or amount set by each merchant.

7. The data analytics method of claim 1 in which a merchant can set the payment commission percentage or amount by modifying a user interface, such as entering the percentage or amount as figures, or moving a slider or other control feature.

8. The data analytics method of claim 1 in which the incentives include: discounts, cash back, free additional goods or services, vouchers for any of these that are redeemable once a sufficient number are collected.

9. The data analytics method of claim 1 in which the credit or debit card company, such as Visa Inc, Mastercard Incorporated, The American Express Company, exchanges data with the data analytics system over a secure network connection.

10. The data analytics method of claim 1 in which the digital payment company, such as Revolut, exchanges data with the data analytics system over a secure network connection.

11. The data analytics method of claim 1 in which the incentives are offered to relevant potential purchasers on the website of the online retailer.

12. The data analytics method of claim 1 in which the incentives are offered to relevant potential purchasers on online advertising, such as pop-up adverts, banner ads, social media adverts, such as Facebook ads, promoted web search engine results, such as Google Ads promoted web search results.

13. The data analytics method of claim 1 in which the benefits to relevant potential purchasers include more prominently listing or otherwise selectively promoting the merchant in an online retailer's search or recommendations results or in web search results.

14. The data analytics method of claim 1 in which the online retailer, such as Amazon, exchanges data with the data analytics system over a secure network connection.

15. The data analytics method of claim 1 in which the online advertising company, such as Facebook, Google, exchanges data with the data analytics system over a secure network connection.

16. A data analytics method for analysing consumer interest data, comprising the steps, implemented at a data analytics system, of:
(i) giving consumers exposure to direct digital financial incentives for a merchant, such as discounts or coupons delivered to customers' mobile phones;
(ii) directly measuring the actual conversion at the merchant—i.e. directly measuring the actual purchases linked to specific incentives;
(iii) modifying the direct digital financial incentives (e.g. targeting more consumers, targeting different consumers, using different incentives, using more valuable incentives) until the merchant's requirements (e.g. new customer acquisition, increased sales) have been satisfied (e.g. a threshold number has been reached for: new customers, or increased sales).

17. The data analytics method of claim 16 implemented by a data analytics system that is configured to capture: (i) the specific identities of potential consumer that are targeted with one or more financial incentives to purchase goods or services; (ii) the actual value of the financial incentives; (iii) whether the financial incentives were successful in triggering an actual purchase; (iv) the amount of that purchase; and (v) how varying the financial incentives alters actual purchasing behaviour.

18. The data analytics method of claim 16 and implemented by a credit or debit card company, or a digital payment company, or an online retailer, or a physical retailer or an online advertising company.

19. A computer implemented data analytics system for analysing consumer interest data and configured with the following sub-systems:
(a) a sub-system configured for automatically analysing potential purchasers' cashless spending behaviour using a machine learning algorithm to generate a dataset that defines the purchasing behaviour of the potential purchasers, the dataset being segmented or organised across a range of different merchants or types of merchants, and also demographic or other personal parameters;
(b) a sub-system configured for automatically analysing existing purchasers' cashless spending behaviour at a merchant and defining those existing purchasers by a set of merchant-specific demographic or other parameters;
(c) a sub-system configured for automatically searching the dataset to identify relevant potential purchasers that meet the merchant-specific demographic or other parameters;
(d) a sub-system configured for enabling the merchant to set or agree a payment commission percentage or amount to a credit or debit card company, or a digital payment company, or an online retailer, or a physical retailer or an online advertising company;
(e) a sub-system configured to use the payment commission amount set by the merchant to automatically determine the value of incentives, such as discounts, offers or other benefits, to offer to relevant potential purchasers to purchase goods or services from the merchant.

20. A mobile phone app connected to the data analytics system of claim 19, including a user interface with an icon or other control feature that, if selected by a potential purchaser, displays incentives available to that potential purchaser.
